(19) United States
(12) Patent Application Publication
(10) Pub. No.: US 2025/0203497 A1
(43) Pub. Date: Jun. 19, 2025

(54) METHOD FOR DISCOVERY OF NETWORK SUPPORTING LOCALIZED SERVICE

(71) Applicant: Lenovo (Singapore) Pte Limited, Singapore (SG)

(72) Inventors: Genadi VELEV, Darmstadt (DE); Hyung-Nam CHOI, Ottobrunn (DE); Prateek BASU MALLICK, Dreieich (DE); Joachim LÖHR, Wiesbaden (DE)

(21) Appl. No.: 18/849,348

(22) PCT Filed: Mar. 17, 2023
(86) PCT No.: PCT/US2023/064611

§ 371 Date: Sep. 20, 2024

Related U.S. Application Data
(60) Provisional application No. 63/322,605, filed on Mar. 22, 2022.

(51) Int. Cl. H04W 48/16; H04W 48/10; H04W 48/18

(52) U.S. Cl. CPC H04W 48/16; H04W 48/10; H04W 48/18

(57) ABSTRACT

Various aspects of the present disclosure relate to a method, apparatus and system that support discovery of a network supporting a localized service. A method for network discovery performed by user equipment in a telecommunications network includes initiating the network discovery based on a trigger event, receiving broadcast information comprising an indication indicating availability of at least one network supporting a localized service, constructing a list of available networks supporting the localized service, and selecting a first network from the list of available networks. The selected network may be a network other than the home network of the user equipment that provides localized services at a particular time and/or location.

### CROSS REFERENCE TO RELATED APPLICATIONS

This application claims priority to U.S. Provisional Patent Application No. 63/322,605, filed on Mar. 22, 2022, entitled METHOD FOR HOSTING NETWORK DISCOVERY, which is hereby incorporated by reference in its entirety.

### TECHNICAL FIELD

The present disclosure relates to wireless communications, and more specifically to a method and an apparatus configured to discover a network supporting a localized service in a public network environment.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

UEs are conventionally configured by an operator with a list of networks available in a Public Land Mobile Network (PLMN). The steering of UE to particular networks, especially in roaming situations, is supported by the network selection procedure specified in 3GPP TS 23.122 V17.4.0 (2021-09). Automatic network selection conventionally uses an “Operator controlled PLMN selector with Access Technology” list, which is a list of preferred PLMN/access technology combinations, and which can be stored in a Universal Subscriber Identity Module (USIM) profile and/or in the Mobile Equipment (ME) part of the UE.

The format of the Operator controlled PLMN selector with Access Technology list is specified in 3GPP TS 31.102 v17.3.0, in clause 4.2.53. Each PLMN ID is associated with 16 bits (2 bytes) of information which can be set to indicate one or more radio access technologies which UE is allowed to use in the respective PLMN.

In addition to the pre-configured lists of PLMNs in the USIM profile, the Home PLMN (HPLMN) may provide the steering of roaming (SoR) information to the UE using the control plane (CP) mechanism specified in 5G for UEs in N1 mode of operation. This allows on-demand updates of the list of PLMNs for network selection. Accordingly, the conventional process for network discovery is generally limited to steering UEs to base stations that are established and operated by the operator of a given PLMN.

### SUMMARY

The present disclosure relates to methods, apparatuses, and systems that support hosting network discovery in a home network environment. By initiating network discovery from a trigger event and receiving broadcast information indicating the availability of one or more available network supporting a localized service, a communication device can register with a network that is present in a limited time or location from within a home network, and would not otherwise be discoverable by the communication device. Registration with the networks supporting the localized service may be automatic or manual, providing users, service providers and network operators with many options for providing seamless wireless coverage and specific localized services.

Some implementations of the method and apparatuses described herein may further include initiating network discovery of a network supporting a localized service based on a trigger event, receiving broadcast information indicating availability of at least one network supporting the localized service, constructing a list of available networks supporting the localized service, and selecting a first network supporting the localized service from the list of available networks supporting the localized service.

In some implementations of the method and apparatuses described herein, the trigger event is at least one of a user input to enable access to the localized service, a roaming status, a location, and a time.

In some implementations of the method and apparatuses described herein, the user equipment is configured with local service information including a time period and a location for which the first network supporting the localized service is available.

In some implementations of the method and apparatuses described herein, the information indicating availability of the at least one network supporting the localized service identifies at least one localized service respectively provided by the at least one network supporting the localized service.

In some implementations of the method and apparatuses described herein, the information indicating availability of a first network supporting the localized service is an indication received in a first system information block broadcast by a base station of a home network providing service to the apparatus.

Some implementations of the method and apparatuses described herein may further include receiving a second system information block comprising network information including at least one of a service identifier and a human-readable service name of the first network supporting the localized service.

Some implementations of the method and apparatuses described herein may further include preparing a list of suitable networks supporting the localized service using the network information in the second system information block.

Some implementations of the method and apparatuses described herein may further include transmitting a random access channel (RACH) request to a base station of the home network based on the indication in the first information block, and the second information block may be received over the random access channel.

Some implementations of the method and apparatuses described herein may further include registering with the selected network supporting the localized service by transmitting a registration request message including a network access indication.

### BRIEF DESCRIPTION OF THE DRAWINGS

FIG. 1 illustrates an example of a wireless communications system that supports hosting network discovery in accordance with aspects of the present disclosure.

FIG. 2 illustrates an example of a hosting network that supports connectivity or services to home network or localized service in accordance with aspects of the present disclosure.

FIG. 3 illustrates an example of a signaling diagram that supports network discovery in accordance with aspects of the present disclosure.

FIG. 4 illustrates a flowchart of a method that supports network discovery in accordance with aspects of the present disclosure.

FIG. 5 illustrates an example of a flowchart of a method that supports network discovery in accordance with aspects of the present disclosure.

FIG. 6 illustrates an example of a signaling diagram for configuring a UE for network discovery in accordance with aspects of the present disclosure.

FIG. 7 illustrates an example of a flowchart of a method that supports network discovery in accordance with aspects of the present disclosure.

FIG. 8 illustrates an example of a signaling diagram for configuring a UE for network discovery in accordance with aspects of the present disclosure.

FIG. 9 illustrates an example of a block diagram of a device that supports network discovery in accordance with aspects of the present disclosure.

### DETAILED DESCRIPTION

With the advance of 5th generation (5G) services and networks, it may be possible to deploy 5G networks at various venues or locations. For example, networks may be deployed at a sports stadium, concert venue, fairgrounds, shopping center, etc., and may offer services that are specific to the location or to an event taking place at the location. Such local 5G networks may offer one or more localized services, in addition to connectivity to non-localized services as well as services to public network operators. The localized services may be provided at specific times and geographic locations, and the 5G network may act as a hosting network offering access to such localized services. The network supporting the localized service can be either a public network such as a Public Land Mobile Network (PLMN) or a non-public network (NPN), and the NPN can be an SNPN or PNI-NPN.

There may be multiple networks with overlapping coverage offering various localized services. UEs may not be aware which localized services are supported by each network. There is a lack of processes for a UE to discover one or more networks providing localized services. Conventional technology lacks a solution for providing how and under which conditions a UE triggers network discovery and selection.

To enable a UE to use localized services, the UE may be configured to discover, select and access a network supporting a localized service. The network may provide localized services, so embodiments of the present disclosure may provide access to localized services that would not otherwise be available. Discovery, selection and access the network and localized services may be based on broadcasting the supported localized services by a home access network, which may be, for example, NG-RAN or non-3GPP access network. In this disclosure, a network supporting a localized service may be referred to as a hosting network.

Benefit of embodiments of the present disclosure include configuration of a UE to perform network selection for hosting networks supporting localized services. The UE is able to apply automatic or manual network selection. The UE access stratum (UE AS) is instructed to discover available networks operating as hosting network for localized services, and the UE AS reports the discovered available hosting networks to the upper layers. The UE, in the case of automatic network selection, or the user, in case of manual network selection, is able to select the appropriate hosting network from the reported discovered available networks. Discovery and selection of an appropriate hosting network may be accurately conducted with high accuracy and efficiency in a variety of situations, including extending network coverage and providing localized services that may not otherwise be available on a home network.

Aspects of the present disclosure are described in the context of a wireless communications system. Aspects of the present disclosure are further illustrated and described with reference to device diagrams, flowcharts that relate to hosting network discovery.

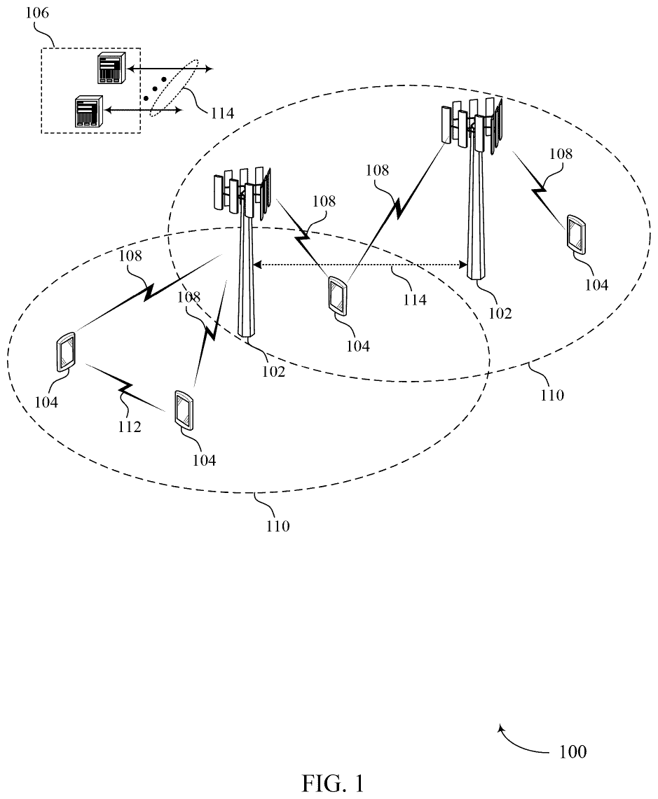

FIG. 1 illustrates an example of a wireless communications system 100 that supports hosting network discovery in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wireless communication over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

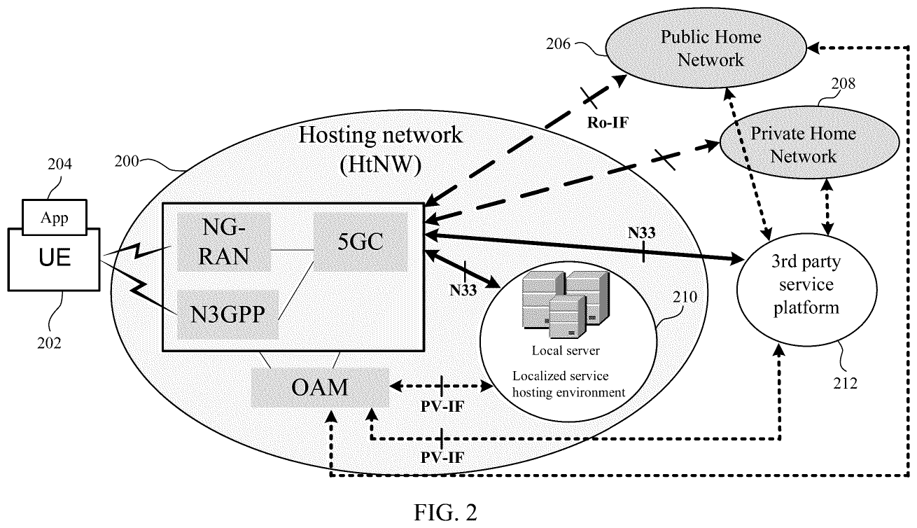

An example of a hosting network deployment is shown in FIG. 2. The hosting network can be either a public network such as a PLMN or an NPN, and the NPN can be an SNPN or PNI-NPN.

The local network may be referred to as a hosting network, and may be deployed as a non-public network or as a public network. The hosting network 200 can offer various services.

In an embodiment, the hosting network 200 offers non-local services to one or more public networks, such as a first HPLMN, or Internet access services. A service level agreement between the hosting network 200 and a HPLMN may be present which may offer, for example, default IP access using local break out (LBO), and/or home-routed services to the HPLMN. The home-routed services may be services for IP Multimedia Subsystem (IMS) applications. In such embodiments, the localized service may be a connectivity or communication service to a home network, in which the hosting network 200 acts as a neutral host. This functionality may be referred to as neutral host network infrastructure. In such embodiments, the UE registers with the hosting network using the identity and the credentials from the home network. For example, the hosting network may be an SNPN and may offer registration with credentials from credential holder (CH), wherein the CH is the home network.

In an embodiment, the hosting network offers local services. The local services may be enriched compared to services that are offered by an Internet connection alone. In some embodiments, the localized services provide information, instructions or incentives to conveniently access the localized services. In the example of FIG. 2, a software application 204 is installed in a UE. A server for the application may be deployed locally in the hosting network 200 domain as a local server 210 or in a third party domain outside the hosting network 200 domain.

The hosting network 200 may offer services from third party providers. These services are indicated as third-party service platform 212 in FIG. 2.

The third party service platform 212 may be operated by an entity that is different from the entity that operates the hosting network or the home network 206. The third-party service providers may offer services to either the hosting network or to one or more HPLMN based on different time or location conditions.

The local service may be enriched compared to services offered via an Internet connection. Users of the local services may be provided with information or instructions to conveniently access the localized services. In the example of FIG. 2, a localized service is used by an application 204, where the application's client is installed in the UE 202 and application's server is deployed either locally in the hosting network domain as local server 210 or in a third party domain outside the domain of hosting network 200. The UE 202 may be a UE 104 shown in FIG. 1.

The third-party service platform 212 may be operated by an entity that is different from an entity that operates the hosting network 200 or home network 206. In some embodiments, the provider of third party services may offer services to the hosting network or public network, and in particular, the provider of third party services may offer services to the hosting network or public network that are limited to certain time and location conditions.

The home network 206 shown in FIG. 2 may be, for example, an HPLMN, a Stand-alone Non-Public Network (SNPN), or a credential holder (CH), and the “home” aspect is from a UE's perspective. For example, the home network 206 may be the network to which the UE 202 has subscribed, and the home network stores and manages the UE's subscription data, the UE's Subscription Permanent Identifier (SUPI) and credentials. Home Network 206 may hold the universal subscriber identity module (USIM) credentials of UE 202 and provide IMS services to the UE.

A hosting network may be different from pre-existing networks such as Rel-16/17 SNPN or PNI-NPN, or PLMN in several respects. For example, the hosting network may be characterized by the ability to broadcast one or more supported localized service. If a UE 202 wants to discover a hosting network, the UE 202 may perform a search constrained to networks offering such services within a home network which broadcasts or otherwise announces support of the desired localized service. The support of localized service can be broadcasted in addition to the support of a) access using credentials owned by a CH separate from the SNPN, or b) access an Onboarding Network (ONN) for the purpose of provisioning the UE 202 with SNPN credentials.

There are many potential embodiments of deployments of a hosting network 200. In one example, the hosting network 200 is deployed in a location in which a high number of users are expected to congregate, such as a stadium, trade fair or concert venue, where the coverage of the hosting network overlaps with the coverage of home networks 206 and 208. In other examples the hosting network 200 may provide coverage in areas where there is no coverage provided by a HPLMN.

An example of extending coverage to an area that lacks coverage is a fairground established away from other wireless network infrastructure, in which the hosting network plays the role of neutral host. Embodiments of a hosting network 200 may be deployed in areas in which coverage already exists, in which case the hosting network may provide additional coverage to accommodate a large number of users or provide localized services that are enriched compared to conventional home network services. In other embodiments, a hosting network 200 may be deployed in an area that would not otherwise have adequate coverage from public networks.

The hosting network and the localized services can be operated by entities that are different from the entities operating the public networks such as home network 206 or 208 or service providers, such as providers of entertainment, shopping, searching and gaming. Furthermore, the hosting network 200 may be only available in limited time periods and locations. For example, the hosting network 200 may be limited to the time and location at which an event is occurring. The localized services can offer a better user experience compared to those that are available over an Internet connection. The local services can be established as needed on a short-term basis, without the need for long term business relationships, permanently installed equipment, and other factors that contribute to the time and expense necessary to establish conventional network equipment.

In an embodiment, the UE 202 may be a subscriber from public network 206 and either the UE 202 or the application 204 or the end user need information/configuration to select hosting network and the localized services. In another use case, the UE 202 may be a subscriber of a service and the UE may use the service-level configuration to know when to trigger hosting network discovery, and optionally whether the hosting network 200 is available in a specific time period and/or specific location.

A provisioning interface, shown as PV-IF in FIG. 2, is used to provision or negotiate various localized service requirements, including QoS, expected/maximum number of users, event information for discovery, network slicing, desired IP connectivity, and routing policies.

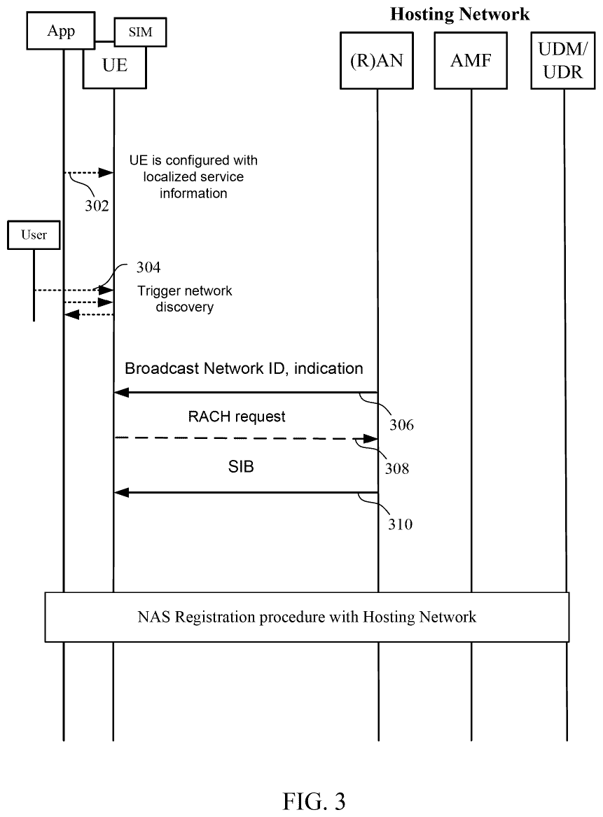

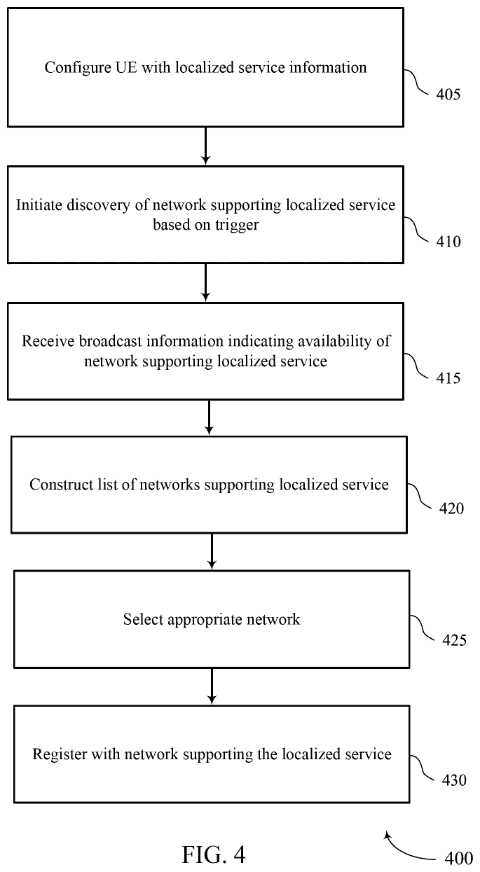

FIG. 3 illustrates an embodiment of a signaling diagram for an embodiment of hosting network discovery, and FIG. 4 illustrates a flowchart of a method 400 that supports network discovery in accordance with aspects of the present disclosure. The operations of the method 400 may be implemented by a device or its components as described herein. For example, the operations of the method 400 may be performed by a UE 202 as described with reference to FIGS. 1 and 2. In some implementations, the device may execute a set of instructions to control the function elements of the device to perform the described functions. Additionally, or alternatively, the device may perform aspects of the described functions using special-purpose hardware.

The method 400 may include discovery and selection of a service-based hosting network. In an embodiment, the hosting network, e.g. a network supporting a localized service, is discovered and selected based on the localized service or application which it supports.

At 405, the method may include configuring a UE with localized service information. The operations of 405 may be performed in accordance with examples as described herein. In some implementations, aspects of the operations of 405 may be performed by a device as described with reference to FIG. 1.

In an embodiment, as indicated in FIG. 3, the UE is configured with information for how to select a hosting network supporting a localized service and/or localized services by signal 302, and the configuration may be performed by an application 204. The UE may be configured with localized service information, which may otherwise be described as network selection criteria for hosting network associated with a localized service, or more generally, service availability information. Such information may characterize the (localized) service identification, such as a service name or identifier, and may further comprise a location and a window of time for which a localized service is available.

In some embodiments, configuration of the UE at 405 may be performed in advance of network discovery, or not performed at all. Even without configuring the UE at 405, the UE may perform discovery and selection of networks supporting a localized service. For example, in an embodiment, network selection may be performed manually where the user of the UE or a specific application can process broadcast information and select a suitable network.

In an embodiment, the UE is configured with the name of a localized service, and the name may be mapped to a service identifier. In addition, the UE may be configured with selection criteria for the hosting network, which may include a time period and location for which the hosting network is available. The configured service information may be stored in the NAS layer in the UE.

The UE is configured with localized service information which may be stored in a NAS layer configuration. In an embodiment, configuration may be performed well before exposure to a hosting network. For example, the UE may be configured a provisioning or service onboarding procedure.

The localized service information may be network selection criteria for hosting networks associated with a localized service, or more generally service availability data from the network or service provider point of view, or service configuration data from the perspective of UE point of view. The localized service information may include at least one of the following information.

A first information of the localized service information is a human readable localized service name (HRSN), e.g. “football league live streaming.” The localized service information may further include mapping between the HRSN and one or more application identifier, which may be an identifier of the application, or service identifiers which identify services associated with the localized service. In some embodiments, the application identifier or the service identifier can map to one or more HRSNs.

A second information of the localized service information is how an application identifier maps to one or more service identifier, or vice-versa, how one or more service identifier maps to an application identifier.

A third information of the localized service information is service availability conditions or network selection criteria for hosting networks, which may include information such as a time period or location for which the services are available. For example, the third information may include information indicating that for a first application, one or more hosting network is available during a specific time period which may include a start time value and an end time value. The start and end time values may include times, days, weeks, months, and years. The location information may include a location of a cell or base station of a current registered PLMN, and more specifically, may be a cellular identifier, a Tracking Area Identify (TAI), a geolocation, or any indicator of a specific geographic area. The time and location information may be present for any number of hosting networks.

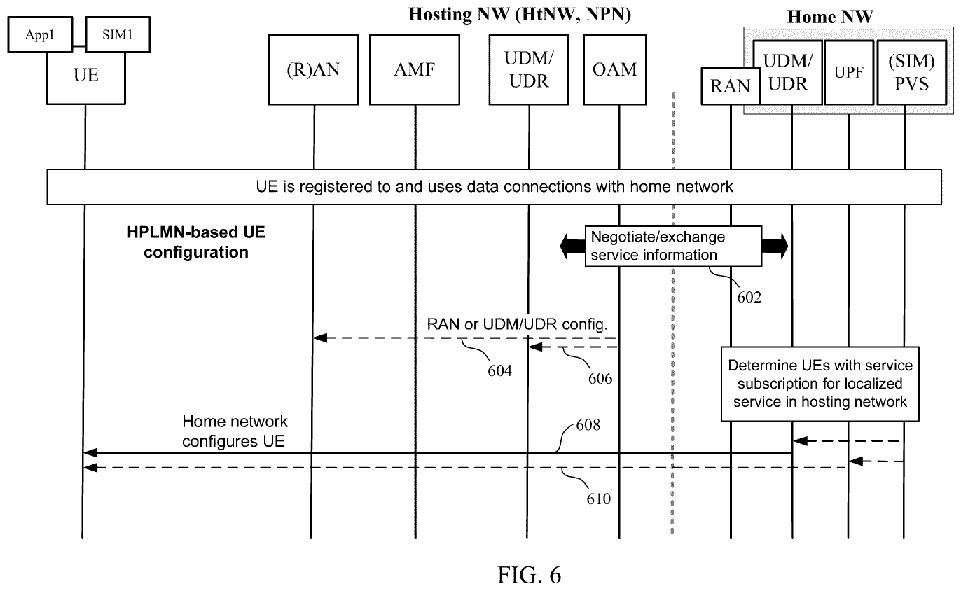

Although FIG. 3 shows the UE being configured with localized service information from an application installed on the UE, in another embodiment, the localized service information is sent to the UE from the UE's home network. The home network may have established a relationship or service level agreement with the hosting network to allow home network's subscribers to register and use services including localized services in the hosting network. Such negotiation may be performed between the business support interfaces of the business support system (BSS). Then the BSS may propagate the corresponding service-related or network slice related configuration in the operations, administration and management (OAM) entity in each of the networks. Further details of this embodiment are shown in FIG. 6.

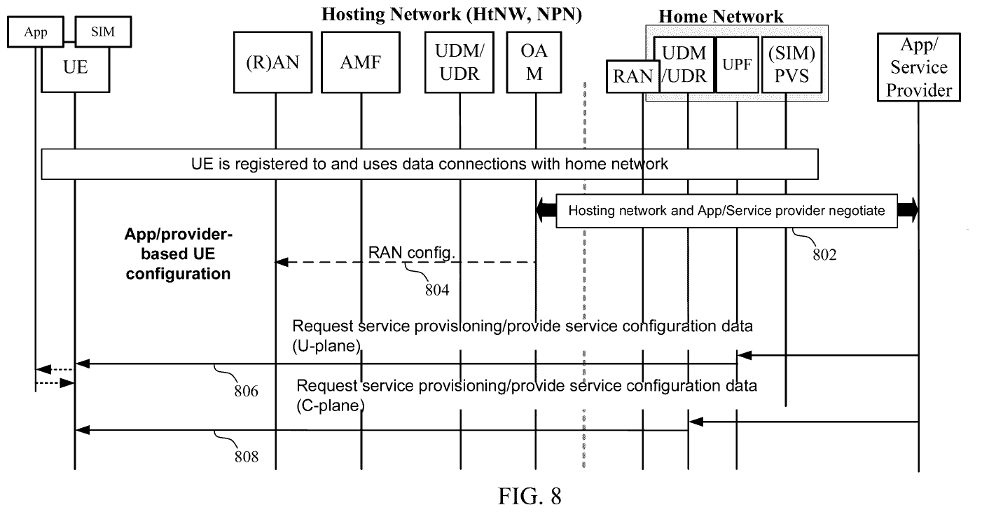

In another embodiment, a service provider (SP) may also provide the localized service information to the UE. The SP and the hosting network may also have a service relationship. The hosting network, and in particular the OAM system of the hosting network, and an application or service provider may negotiate that a certain service, such as a specific application, may be deployed locally in the hosting network. Further details of this embodiment are shown in FIG. 8.

The application may be deployed in one or more hosting network and associated with different conditions. For example, an application or local service identifier may be supported by a first hosting network associated with a first service availability criteria including a first time period and first location, and supported by a second hosting network associated with a second service availability criteria including a second time period and second location.

In addition, if the UE is in RRC-CONNECTED state, the UE may be configured with a measurement object (MO) to start measuring on a specific frequency. For example, the frequency may be the one where a hosting network operates.

In an embodiment, the service ID may be provided and stored in form of string of characters or digits, e.g. “1234”. The HRSN may be a Private Service Identity which is applicable to a user and is similar to a Private User Identity in the form of a Network Access Identifier (NAI), which is defined in IETF RFC 4282, for example “streamig@example.com”, or only a domain name such as “example.com”.

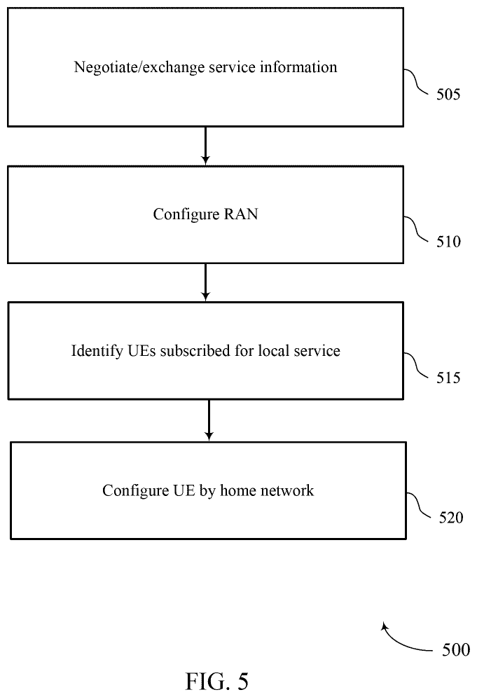

Another embodiment of configuring UE with service information is described later in the present disclosure with respect to FIGS. 5-8.

At 410, the method may include initiating discovery if one or more network supporting a localized service based on a trigger. The operations of 410 may be performed in accordance with examples as described herein. In some implementations, aspects of the operations of 410 may be performed by a device as described with reference to FIG. 1. In an embodiment, a UE's NAS layer requests the AS layer to discover available hosting networks which may indicate support of one or more localized service. Several different embodiments of a trigger and initiation of hosting network discovery are possible.

In one embodiment, as seen in FIG. 3, the trigger 304 is provided from a higher layer such as the application or the user of the UE. Here, the trigger may be a request to discover a hosting network offering a particular service. For example, in an embodiment, a user may provide an input in response to a prompt related to services that the user is interested in, in which case the user input may be a trigger. In an embodiment, the user input enables access to a localized service.

In another embodiment, an application running on a UE transmits a request to the UE to initiate discovery of available hosting networks, in which case the request from the application is the trigger. Such requests may be sent by the higher layer or user to the NAS layer. The request to the NAS layer may include a service ID if the NAS layer has been configured with the service availability conditions. In another embodiment, the request to the NAS layer includes the application ID and the NAS layer performs matching to the service ID. Although FIG. 3 only illustrates signals from the user and an application to the UE, other embodiments of triggers are possible.

In an embodiment, the AS layer determines that an out-of-coverage situation is present, and may further determine that there is no connection to potentially pre-configured networks in the AS. The AS layer informs NAS about no coverage situation. If the NAS layer determines that there is no roaming network (e.g. VPLMN) currently available, and the NAS layer is aware that a hosting network can be used as a neutral host to provide HPLMN services, the NAS layer may trigger discovery and selection of a hosting network which offers communication or connectivity service to the home network. In such an embodiment, the UE may use localized service information containing service availability conditions such as a time period and location.

In another embodiment, the trigger event for hosting discovery may be based on the UE configuration at 405. This may include a trigger based on, for example, a time period or footprint or location information. The footprint information may be location selection criteria where the UE may know that it is within an area in which hosting networks and connection via hosting network is present, desired or preferable.

The network discovery procedure may be performed by the AS layer. The upper layers, e.g. the NAS layer, may be configured at 405 with information for service availability such as time period and location. The NAS layer may send a request to the AS layer to discover available hosting networks associated with a localized service.

For example, the information provided to the AS layer may include at least one of: a) instructions to consider only hosting networks supporting any localized service; b) instructions to search for networks supporting one or more specific localized service, which may be identified by a Service ID; and c) radio access technology (RAT) preference and frequency information (band or carrier frequency) of the candidate hosting networks. If such frequency information is provided to the UE AS, the UE AS may search only in a limited number of frequency bands and carrier frequencies and the overall network discovery procedure will be shorter.

At 415, the method may include receiving broadcast information indicating the availability of a network supporting the localized service. The operations of 415 may be performed in accordance with examples as described herein. In some implementations, aspects of the operations of 415 may be performed by a device as described with reference to FIG. 1.

In an embodiment, the access network broadcasts information about supported localized services or the availability of one or more hosting network. The UE AS layer may search for available cells from networks according to a NAS request received at 410, and the UE AS may prepare a list of discovered hosting networks matching the criteria. The broadcast information about the supported localized services may include one or more of the following components.

A first component, which is a hosting network indication which indicates that the network or current cell supports any localized service. The hosting network indication can be transmitted in a system information block (SIB) 306, which may be SIB that is transmitted with relatively high frequency. For example, the system information block may be SIB #1 or SIB #2. The indication may be, for example, one, two or more bits of information provided in a SIB that is broadcast by a base station of a hosting network. The broadcast information may have a second component in addition to or alternative to the indication. The second component may include at least one of a service identifier and an HRSN identifying the localized service.

The NAS layer may consider service availability criteria that is configured on the UE at 405. The NAS layer may request the AS layer to discover available hosting networks based on such hosting or localized service selection criteria such as a time period and location, and the identification of the localized service.

In another embodiment, the NAS layer requests the AS layer to discover any available network and provides an indication to also report whether the available network supports hosting network capability and localized service. The AS layer may report to the NAS layer any available networks including: i) networks which do not support hosting network capability, and ii) networks which support hosting network capability and, if available, the corresponding localized services, which may be identified by a service identifier.

In another embodiment, the NAS layer transmits a request to the AS layer to discover all networks supporting any localized services. The AS layer reports to the NAS layer all available networks which have broadcasted a hosting network indication, and if available, the corresponding localized service IDs.

In another embodiment, the NAS layer requests the AS layer to discover only networks which support particular service IDs. In such an embodiment, the NAS layer may also provide the localized service IDs to the AS layer. The AS layer may report to the NAS layer all available networks which have broadcasted a hosting indication and the corresponding localized service IDs.

Regarding the location selection criteria, e.g. a location of the hosting network or service selection criteria, either the NAS layer or the AS layer may evaluate the location selection criteria. If the UE AS is to evaluate the location selection criteria, the UE NAS may also indicate location information to the UE AS. The location information may be a cellular network location such as a cell coverage area or set of coverage areas, or a geographic location, for example. The AS layer may know the location footprint and trigger the hosting network discovery procedure autonomously.

In an embodiment, the AS layer may search in different frequency bands to discover cells for which the measured cell attributes satisfy the cell selection criterion and the cells are not barred. Cell selection criterion may be the criterion defined in 3GPP TS 38.304 clause 5.2.3.2. For the purposes of this disclosure, such cells may be referred to as available cells. By considering the available cells, the UE constructs a list of available networks, and the UE may consider any SNPN or PLMN network at this phase. The UE may attempt to read the SIB broadcast at 415 to identify whether the network is a hosting network. The UE may that the network is a hosting network based on at least one of: a hosting network indication, a service identifier, and an HRSN identifying the localized service. The reception of the broadcast information may be performed either i) when the UE is in idle state for a current network registration (e.g. out-of-coverage or normal camping on a cell), or ii) the UE is in connected state for a current network registration (e.g. exchanging data or signaling with the current network) and in parallel the UE searches for cells of hosting network; or iii) the UE is currently not registered to any network (e.g. in mobility management deregistered state).

At 420, the method may include construct a list of networks supporting a localized service (e.g. hosting networks). The operations of 420 may be performed in accordance with examples as described herein. In some implementations, aspects of the operations of 420 may be performed by a device as described with reference to FIG. 1.

The AS layer may report the list of discovered available networks to the NAS layer. The NAS layer may construct a list of suitable networks wherein the suitable networks are networks supporting the localized service.

In an embodiment, the UE reads the broadcasted system information, for example Minimum System Information (MSI) which may comprise the master information block (MIB) or SIB, for a cell with a signal strength above a threshold. The cell may be a cell considered by the UE as a suitable cell according to the cell selection criterion. The UE may identify the network ID (e.g. PLMN ID, SNPN ID (containing of PLMN ID and Network Identification (NID))), an indication whether the cell and possibly the network supports localized service, or whether the network acts as hosting network. For example, the SIB may contain a new hosting network indication which indicates to the UE whether the network acts as hosting network, as discussed above with respect to 415.

Optionally, if the UE determines that a discovered cell belongs to a hosting network, but the dedicated SIB containing the information for service discovery is not broadcasted in the cell, the UE may request the RAN of the hosting network to provide a dedicated SIB for service discovery. As indicated in FIG. 3, the UE may transmit a random access channel (RACH) request 308 to the hosting network for the dedicated SIB.

In an embodiment, the UE receives a second SIB 310 in response to the RACH request. The UE reads the second SIB, which may contain information for service discovery. For example, the information may contain one or more service IDs with optionally corresponding HRSNs. The service IDs and corresponding HRSNs may indicate to the UE that the current cell supports connectivity to a hosting network which supports the identified services.

At 425, the method may include selecting an appropriate network supporting the localized service. The operations of 425 may be performed in accordance with examples as described herein. In some implementations, aspects of the operations of 425 may be performed by a device as described with reference to FIG. 1.

In an embodiment, the UE AS layer reports the list of discovered hosting networks fulfilling the requested condition to the UE NAS. In particular, the UE NAS layer may evaluate reported discovered hosting networks and construct a list of suitable hosting networks to be selected as serving network. The UE NAS layer may request the UE AS layer to select a cell of a candidate hosting network.

The UE AS layer may report one or more discovered available networks and optionally their corresponding measurement results with criteria such as associated services, time and location at 415. If more than one hosting network supporting the UE's service of interest is detected, the network with the strongest radio signal may be selected by the UE.

If the UE NAS has requested discovery of all hosting networks, the UE AS may provide a list of all available non-hosting networks and all hosting networks, whereas the latter may also include the supported localized services associated with each hosting network. For example, the UE AS layer may report: 1) a list of non-hosting networks, such as a list of network IDs, and/or 2) a list of hosting networks in addition to a list of supported service IDs associated with each hosting network. The network IDs may be, for example, a PLMN ID (a combination of mobile country code (MCC) and mobile network code (MNC)) or an SNPN ID (PLMN ID and NID).

If the UE NAS has requested discovery of hosting networks supporting one or more specific service ID, the UE AS may provide a list of the available hosting networks which support the requested service IDs. For example, the UE AS layer may report a list of network IDs associated with specific service IDs.

In an embodiment, if manual network selection is performed, registration may include displaying the list of discovered networks to the user. The user may then select a desired hosting network from the list of discovered networks. In an automated process, the NAS layer or a higher layer, such as an application, makes the selection instead of the user. If the selected home network is an SNPN (identified by PLMN ID and NID), the UE may activate the SNPN access mode. During the hosting network selection process, the UE may perform the selection either in activated SNPN access mode or in deactivated SNPN access mode. In any case, if the UE selects an SNPN as hosting network, the UE may activate the SNPN access mode.

At 430, the method may include registering with a network supporting a localized service. The operations of 430 may be performed in accordance with examples as described herein. In some implementations, aspects of the operations of 430 may be performed by a device as described with reference to FIG. 1.

The UE initiates a registration procedure with the selected hosting network. The UE may indicate to the network during the RRC connection establishment that the UE intends to use the network as hosting network. In other words, the UE performs a kind of hosting network access, and may transmit an associated indication to the hosting network. Based on this indication, a base station of the RAN of the hosting network can select an appropriate AMF to which the UE's NAS message is forwarded. This is especially helpful when the hosting network deploys multiple AMFs and some AMFs are assigned to serve the UEs accessing the network, such as an SNPN, for localized services, or the UEs are not subscribers of the SNPN itself, whereas other AMFs are assigned to serve the SNPN's own subscribers which do not access the network for localized services. When the NAS layer attempts to register with the hosting network to use localized services, the NAS layer indicates to the AS layer that the access is for hosting network access. Furthermore, the base station may use the indication that the UE accesses the network as hosting network to perform access control specific to such UEs (e.g. accessing to use localized services), or the base station can apply further processing specific to UE accessing the network as hosting network.

In addition or alternatively, the UE may provide a hosting network access indication in the in the NAS registration request message. Such an indication may allow the AMF to use local configuration data for UE accessing the network to use localized services (accessing the network as a hosting network). For example, the local configuration data may include at least one of: a pre-configured network slice, which may be identified by S-NSSAI, or Data Network Names (DNN) can be used by the AMF; or specific data for SMF selection. The further steps of the registration procedure are performed according to the registration procedure 3GPP TS23.502 clause 4.2.22.

FIG. 5 illustrates a flowchart of a method 500 that supports configuring a UE for hosting network discovery in accordance with aspects of the present disclosure. In particular, method 500 may be a method for configuring a UE with service availability data for services associated with a hosting network. The operations of the method 500 may be implemented by a device or its components as described herein. For example, the operations of the method 500 may be performed by one or more element of a wireless communications system 100 as described with reference to FIG. 1. In some implementations, the device may execute a set of instructions to control the function elements of the device to perform the described functions. Additionally, or alternatively, the device may perform aspects of the described functions using special-purpose hardware.

The UE may use the information configured in method 500 to trigger the hosting network discovery and to search for the appropriate networks supporting the localized services of interest as discussed above with respect to method 400. For example, if the user of the UE or an application on the UE request connectivity for a localized service, the UE uses the service availability data to trigger or perform the hosting network discovery and selection. Alternatively or in in addition to service-triggered network discovery, the UE may use the service availability data to trigger network discovery in case of out-of-coverage in the current registered network. Method 500 may be performed at 405 of method 400.

FIG. 6 is a signal diagram illustrating an embodiment of performing method 500. As illustrated in FIG. 6, the UE may be registered to and have established connectivity to a network, for example, to a home network, or using WLAN offload when connected via WiFi network.

At 505, the method may include negotiating and/or exchanging service information. The operations of 505 may be performed in accordance with examples as described herein. In some implementations, aspects of the operations of 505 may be performed by a device as described with reference to FIG. 1.

As illustrated in FIG. 6, the hosting network OAM system (or business support systems, BSS) and the home network OAM system (or BSS) may negotiate service information at 505. In an embodiment, the hosting network and home network negotiate service availability data and criteria and further details about the deployment and adoption of a localized service using signaling 602. This process may include establishing a service level agreement (SLA) for roaming service or for service deployment, and the SLA may be for localized service deployment. In an embodiment, the service ID and the availability criteria may be specific to a hosting network-for example, if an application or Service provider negotiates with multiple hosting networks, an individual service ID and availability criteria may be associated with each respective hosting network.

Examples of parameters that may be negotiated or exchanged at 505 are an HRSN, e.g. “football league live streaming.” and how the HRSN maps to one or more service IDs or to one or more client application IDs. Accordingly, embodiments can accommodate multiple hosting networks for what a user perceives as the same service. Alternatively, the service ID or application can map to one or more HRSNs.

Another example of parameters that may be negotiated or exchanged is one or more service IDs of the localized service supported in the hosting network. For example, a first application (App1) maps to a first service ID (ServID #1), while a second application (App2) maps to a second service ID (ServID #2).

Another example of parameters that may be negotiated or exchanged is service availability information, such as a time period and location associated with the negotiated service or application. An example of a localized service ID that is negotiated or exchanged at 505 is as follows: Service ID #A=234567, which corresponds to App1/Service Name=“Racing Game”. Here, for a UE, when App1 (a racing game) wants to use network connectivity to send and receive data, the UE looks for the availability of Service ID #A=234567.

At 510, the method may include configuring a RAN, e.g. of the hosting network. The operations of 510 may be performed in accordance with examples as described herein. For example, the RAN can be configured (e.g. by the OAM system using signal 604) to broadcast the information in the SIBs as described in FIG. 4 at 415. In some implementations, aspects of the operations of 510 may be performed by a device as described with reference to FIG. 1.

In the home network, the OAM system configures the RAN and/or the 5GC with corresponding data to allow the use of the localized service at 510. In particular, the OAM system may configure the Unified Data Repository (UDR) or Unified Data Management (UDM) of the home network, as indicated by 606 in FIG. 6. In an embodiment, the OAM system may configure the 3GPP RAN or a non-3GPP access network with the Service IDs supported in the network, wherein the service IDs are the same as service IDs negotiated at 505. The RAN or non-3GPP access network may announce or broadcast these service IDs.

In an alternative embodiment, the service configuration data may be stored in a network function different from the UDR. In one example, an existing network function like steering-of roaming application function (SoR-AF) may store the service configuration data and may initiate the UE configuration update procedure, e.g. via the control plane signaling by using the UPU procedure. In another example, a new network function (which may be called service-based configuration application functions, SBC-AF) may be used which stores the service configuration data. The SBC-AF may initiate the UE configuration update procedure, e.g. via the control plane signaling by using the UPU procedure. The SBC-AF is able to identify which UEs are to be updated based on the UE subscription for a localized service. For example, the SBC-AF may interrogate with the UDM/UDR to determine the UEs to be updated, or the SBC-AF can initiate the UE provisioning procedure with a service ID as signaling key and the UDM/UDR can translate and replicate the signaling to the UEs which should be provisioned via UPU procedure, wherein further details about the UE provisioning is described in 520.

At 515, the method may include identifying UEs subscribed for one or more local services. The operations of 515 may be performed in accordance with examples as described herein. In some implementations, aspects of the operations of 515 may be performed by a device as described with reference to FIG. 1.

FIG. 6 illustrates an example of a signal diagram that supports hosting network discovery in accordance with aspects of the present disclosure. As illustrated in FIG. 6, the home network determines which UEs are subscribed for localized services negotiated or exchanged at 505. In an embodiment, the determination at 505 may be performed in the UDR or the UDM. the determination may be performed by an entity that stores the user subscription data and service subscription data.

At 520, the method may include configuring a UE by the home network. The operations of 520 may be performed in accordance with examples as described herein. In some implementations, aspects of the operations of 520 may be performed by a device as described with reference to FIG. 1.

In an embodiment, the home network of a UE (e.g. the UDM) initiates a UE configuration procedure in order to send the service configuration data, or localized service availability information, to the UE. In one example, the home network may use the UE Parameter Update (UPU) procedure in order to send the service configuration data to the UE.

The service configuration data, or localized service availability information, may include parameters which were negotiated at 505 and which are used by the UE to discover hosting networks supporting the localized service. For example, the service configuration data may be at least one of: a) mapping of an application ID to an ID of a localized service; b) service availability criteria or conditions such as time period and location; c) a HRSN associated with the service ID or with the application ID; and d) validity information for the service configuration data.

The service configuration data may be encapsulated in a new container of information 608 from the UDM to UE via the AMF. Embodiments may use one or more aspect of the UPU procedure described in 3GPP TS23.502 clause 4.20.2. The transparent container info sent to the UE may updated or enhanced to include the service configuration data.

In an embodiment, the UE receives and stores the service configuration data and may use it as long as the data is valid. The service configuration data may be associated with a validity timer, such that the data is only valid between a first time point and a second time point. The validity of the service configuration data may be different from the time period of the service availability criteria.

In an embodiment, as indicated in FIG. 6, the home network may use the (U) SIM provisioning procedure to send the service configuration data to the UE at 520. The provisioning server may create the service configuration data and send it via the user plane by signal 610 or via the control signaling to the UE. The UE may then store the data in the (U) SIM module or in the ME part of the UE. Storage in the ME may be similar to the steering-of-roaming data received and stored in the UE.

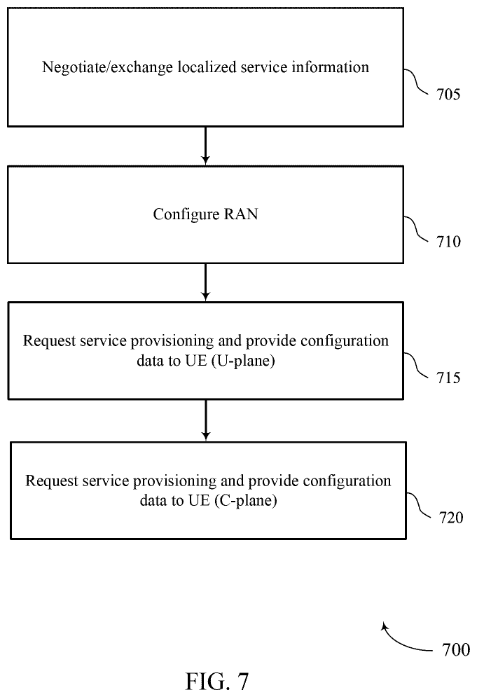

FIG. 7 illustrates a flowchart of another embodiment of a method 700 that supports configuring a UE for hosting network discovery in accordance with aspects of the present disclosure. In particular, method 700 may be a method for configuring a UE with service availability data for services associated with a hosting network. The operations of the method 700 may be implemented by a device or its components as described herein. For example, the operations of the method 700 may be performed by one or more element of one or more wireless communications system 100 as described with reference to FIG. 1. In some implementations, the device may execute a set of instructions to control the function elements of the device to perform the described functions. Additionally, or alternatively, the device may perform aspects of the described functions using special-purpose hardware.

Elements of method 700 are similar to elements of method 500 described above, except that in method 700, aspects of the UE configuration are performed on the application layer. In particular, the service provider may perform the UE configuration by sending service configuration data like the localized service availability information to the UE via application layer signaling received by the application client in the UE.

FIG. 8 illustrates an example of a signal diagram that supports hosting network discovery in accordance with aspects of the present disclosure. FIG. 8 is a signal diagram illustrating an embodiment of performing method 700. As illustrated in FIG. 8, the UE may be registered to and have established connectivity to a network, for example, to a home network, or using WLAN offload when connected via WiFi network.

At 705, the method may include negotiating and/or exchanging service information. The operations of 705 may be performed in accordance with examples as described herein. In some implementations, aspects of the operations of 705 may be performed by a device as described with reference to FIG. 1.

A component of the hosting network such as the OAM system and an application or service provider may negotiate a service level agreement (SLA) for the deployment and availability of the service associated with an application at 705, as indicated by signaling 802 in FIG. 8. 705 is similar to 505, but in 705, the SLA is negotiated between the home network and the application or service provider. After 705, the application or service provider is aware which service ID is allocated to an application in this network. Furthermore, the application or service provider is aware of the service availability criteria such as a time period and location of service availability. Similar to 505, the service ID and the availability criteria may be associated with each hosting network at 705.

At 710, the method may include configuring a RAN. The operations of 710 may be performed in accordance with examples as described herein. In some implementations, aspects of the operations of 710 may be performed by a device as described with reference to FIG. 1.

In the home network, the OAM system configures the RAN and/or the 5GC with corresponding data by signaling 804 to allow the use of the localized service at 710. In an embodiment, the OAM system may configure the 3GPP RAN or a non-3GPP access network with the Service IDs supported in the network, wherein the service IDs are the same as service IDs negotiated at 705. The RAN or non-3GPP access network may announce or broadcast these service IDs.

At 715, the method may include requesting service provisioning and providing configuration data to a UE over the U-plane. The operations of 715 may be performed in accordance with examples as described herein. In some implementations, aspects of the operations of 715 may be performed by a device as described with reference to FIG. 1.

In an embodiment, the service provider can send an application layer signal that includes service configuration data to the application client in the UE at 715. A service provider may transmit a request for service provisioning or configuration, including the service ID in a particular hosting network and service availability data, such as time period and location. The application layer signaling may be sent over the user plane. The provisioning request and service configuration data 806 may be transmitted from the service provider to the UE through the home network, as indicated in FIG. 8.

The application client in the UE receives the application layer signaling. This signaling may include at least one parameter including the mapping of the application to a localized service ID or service availability criteria, e.g. time period and location. In addition, validity data for the service configuration data may be sent to the UE at 715. The validity data may include a start time and an end time that define a period of time in which the service information is valid.

In an embodiment, the application client in the UE may internally request the UE to use the service configuration data. In particular, the UE uses the modem part of the device which may include the operating system, OS, or the NAS layer at 715. In one example, an AT command may be used to send the service configuration data to the UE.

At 720, the method may include requesting service provisioning and providing configuration data 808 to a UE over the C-plane. The operations of 720 may be performed in accordance with examples as described herein. In some implementations, aspects of the operations of 720 may be performed by a device as described with reference to FIG. 1.

Alternatively to 715, at 720, the application or service provider, which may be acting as an Application Function (AF) within the 5GS architecture may send the service configuration data via control plane signaling over the 5GC. In one embodiment, the service configuration data signaling is provided on a per-UE basis from the AF to the home NW.

For example, the AF (e.g. App/Service provider) sends the service configuration data to the Network Exposure Function (NEF) of the home network by using an existing or a new north-bound interface exposure service via the N33 interface (the NEF is not shown in the FIG. 8). The signaling request from the AF includes a UE or user ID as a signaling key, e.g. Generic Public Subscription Identifier (GSPI). The NEF may discover a UDM/UDR serving the UE, and store the data in the UE-specific subscription parameters.

In another embodiment, the service configuration data signaling is provided on a per-application or service basis from the AF to the home network. In such an embodiment, the AF sends the service configuration data to the NEF of the home network, but instead of using the UE ID as signaling key, the AF uses the service identifier of application identifier, as the service configuration data may only be valid to any UE subscribed with the localized service. The UDR may store the service configuration data, and together with the UDM, determine to which UEs the service configuration data will be sent.

In an alternative embodiment, the service configuration data may be stored in a dedicated network function in the network. In one example, an existing network function like steering-of roaming application function (SoR-AF) may store the service configuration data and may initiate the UE configuration update procedure, e.g. via the control plane signaling by using the UPU procedure. In another example, a new network function (e.g. called service-based configuration application functions, SBC-AF) may be specified which stores the service configuration data received from the service provider. The SBC-AF may initiate the UE configuration update procedure, e.g. via the control plane signaling by using the UPU procedure as described in FIG. 5.

In either embodiment, the UDM may initiate the UE parameter update (UPU) procedure to update the UE configuration. The UPU procedure may be enhanced to allow the transport of the new service configuration data, as described above.

After receiving the configuration data, the UE may receive and store the service configuration data and uses this data as long as the data is valid. The service configuration data may be associated with a validity timer, e.g. valid between a first time point and a second time point. The validity of the service configuration data may be different from the time period of the service availability criteria.

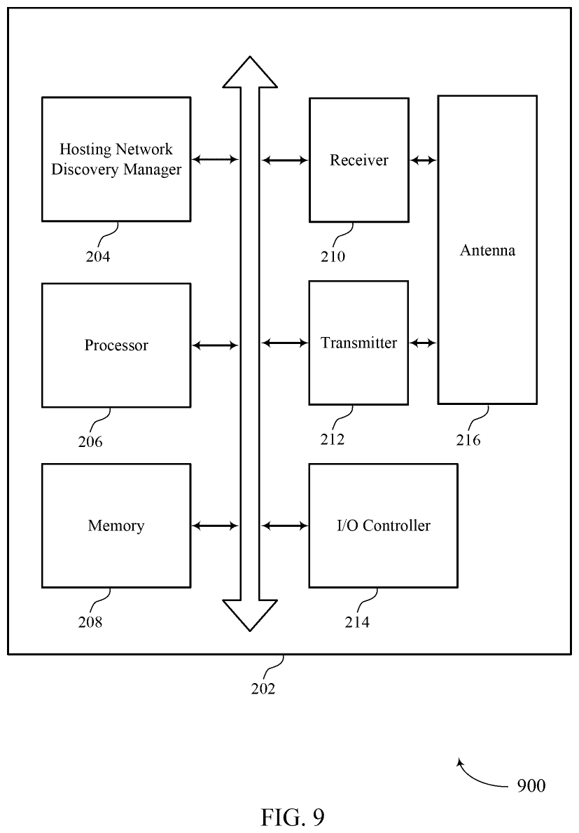

FIG. 9 illustrates an example of a block diagram 9 of a device 900 that supports hosting network discovery in accordance with aspects of the present disclosure. The device 902 may be an example of a network element such as a base station 102, or a UE 104 as described herein. The device 902 may support wireless communication with one or more base stations 102, UEs 104, or any combination thereof. The device 902 may include components for bi-directional communications including components for transmitting and receiving communications, such as a communications manager 904, a processor 906, a memory 908, a receiver 910, transmitter 912, and an I/O controller 914. These components may be in electronic communication or otherwise coupled (e.g., operatively, communicatively, functionally, electronically, electrically) via one or more interfaces (e.g., buses).

The communications manager 904, the receiver 910, the transmitter 912, or various combinations thereof or various components thereof may be examples of means for performing various aspects of the present disclosure as described herein. For example, the communications manager 904, the receiver 910, the transmitter 912, or various combinations or components thereof may support a method for performing one or more of the functions described herein.

In some implementations, the communications manager 904, the receiver 910, the transmitter 912, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 906 and the memory 908 coupled with the processor 906 may be configured to perform one or more of the functions described herein (e.g., by executing, by the processor 906, instructions stored in the memory 908).

Additionally or alternatively, in some implementations, the communications manager 904, the receiver 910, the transmitter 912, or various combinations or components thereof may be implemented in code (e.g., as communications management software or firmware) executed by the processor 906. If implemented in code executed by the processor 906, the functions of the communications manager 904, the receiver 910, the transmitter 912, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 904 may be configured to perform various operations (e.g., receiving, monitoring, transmitting) using or otherwise in cooperation with the receiver 910, the transmitter 912, or both. For example, the communications manager 904 may receive information from the receiver 910, send information to the transmitter 912, or be integrated in combination with the receiver 910, the transmitter 912, or both to receive information, transmit information, or perform various other operations as described herein. Although the communications manager 904 is illustrated as a separate component, in some implementations, one or more functions described with reference to the communications manager 904 may be supported by or performed by the processor 906, the memory 908, or any combination thereof. For example, the memory 908 may store code, which may include instructions executable by the processor 906 to cause the device 902 to perform various aspects of the present disclosure as described herein, or the processor 906 and the memory 908 may be otherwise configured to perform or support such operations.

For example, the [communications] manager 904 may support wireless communication at a first device (e.g., the device 902) in accordance with examples as disclosed herein. The communications manager 904 may be configured as or otherwise support a means for Hosting Network Discovery.

The processor 906 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 906 may be configured to operate a memory array using a memory controller. In some other implementations, a memory controller may be integrated into the processor 906. The processor 906 may be configured to execute computer-readable instructions stored in a memory (e.g., the memory 908) to cause the device 902 to perform various functions of the present disclosure.

The memory 908 may include random access memory (RAM) and read-only memory (ROM). The memory 908 may store computer-readable, computer-executable code including instructions that, when executed by the processor 906 cause the device 902 to perform various functions described herein. The code may be stored in a non-transitory computer-readable medium such as system memory or another type of memory. In some implementations, the code may not be directly executable by the processor 906 but may cause a computer (e.g., when compiled and executed) to perform functions described herein. In some implementations, the memory 908 may include, among other things, a basic I/O system (BIOS) which may control basic hardware or software operation such as the interaction with peripheral components or devices.

The I/O controller 914 may manage input and output signals for the device 902. The I/O controller 914 may also manage peripherals not integrated into the device 902. In some implementations, the I/O controller 914 may represent a physical connection or port to an external peripheral. In some implementations, the I/O controller 914 may utilize an operating system such as iOS®, ANDROID®, MS-DOS®, MS-WINDOWS®, OS/2®, UNIX®, LINUX®, or another known operating system. In some implementations, the I/O controller 914 may be implemented as part of a processor, such as the processor 906. In some implementations, a user may interact with the device 902 via the I/O controller 914 or via hardware components controlled by the I/O controller 914.

In some implementations, the device 902 may include a single antenna 916. However, in some other implementations, the device 902 may have more than one antenna 916, which may be capable of concurrently transmitting or receiving multiple wireless transmissions. The receiver 910 and the transmitter 912 may communicate bi-directionally, via the one or more antennas 916, wired, or wireless links as described herein. For example, the receiver 910 and the transmitter 912 may represent a wireless transceiver and may communicate bi-directionally with another wireless transceiver. The transceiver may also include a modem to modulate the packets, to provide the modulated packets to one or more antennas 916 for transmission, and to demodulate packets received from the one or more antennas 916.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
initiate discovery of a network supporting a localized service based on a trigger event;
receive broadcast information indicating availability of the localized service;
construct a list of available networks supporting the localized service; and
select a first network supporting the localized service from the list of available networks supporting the localized service.

2. The UE of claim 1, wherein the trigger event is at least one of a user input to enable access to the localized service, a roaming status, a location, and a time.

3. The UE of claim 2, wherein the UE is configured with local service information including a time period and a location for which the first network supporting the localized service is available.

4. The UE of claim 1, wherein the information indicating availability of the at least one network supporting the localized service identifies at least one localized service respectively provided by the at least one network supporting the localized service.

5. The UE of claim 1, wherein the information indicating availability of a first network supporting the localized service is an indication received in a first system information block broadcast by a base station of a network providing service to the apparatus.

6. The UE of claim 5, wherein the processor is further configured to cause the UE to receive a second system information block comprising network information including at least one of a service identifier and a human-readable service name of the first network supporting the localized service.

7. The UE of claim 6, wherein the processor is further configured to cause the UE to prepare a list of suitable networks supporting the localized service using the network information in the second system information block.

8. The UE of claim 6, wherein the processor is further configured to cause the UE to transmit a random access channel (RACH) request to a base station of the network supporting the localized service based on the indication in the first information block.

9. The UE of claim 1, wherein the processor is further configured to cause the UE to register with the selected network supporting the localized service by transmitting a registration request message including a network access indication for the network supporting the localized service.

10. A method for network discovery performed by user equipment in a telecommunications network, the method comprising:
initiating the network discovery of a network supporting a localized service based on a trigger event;
receiving broadcast information comprising an indication indicating availability of at least one network supporting the localized service;
constructing a list of available networks supporting the localized service; and
selecting a first network supporting the localized service from the list of available networks supporting the localized service.

11. The method of claim 10, wherein the trigger event is at least one of a user input to enable access to the localized service, a roaming status, a location, and a time.

12. The method of claim 11, wherein the user equipment is configured with local service information including a time period and a location for which the first network supporting the localized service is available.

13. The method of claim 10, wherein the information indicating availability of the at least one network supporting the localized service identifies at least one localized service respectively provided by the at least one network supporting the localized service.

14.-18. (canceled)

19. A base station for wireless communication, comprising:
at least one memory; and
at least one processor coupled with the at least one memory and configured to cause the base station to:
broadcast information indicating availability of at least one network supporting the localized service in a system information block,
wherein the information indicating availability of the at least one network supporting the localized service identifies at least one localized service respectively provided by the at least one network supporting the localized service.

20. The base station of claim 19, wherein system information block comprises at least one of a service identifier and a human-readable service name of the at least one localized service.

21. A processor for wireless communication, comprising:
at least one controller coupled with at least one memory and configured to cause the processor to:
initiate discovery of a network supporting a localized service based on a trigger event;
receive broadcast information indicating availability of the localized service;
construct a list of available networks supporting the localized service; and
select a first network supporting the localized service from the list of available networks supporting the localized service.

22. The processor of claim 21, wherein the trigger event is at least one of a user input to enable access to the localized service, a roaming status, a location, and a time.

23. The processor of claim 21, wherein the information indicating availability of the at least one network supporting the localized service identifies at least one localized service respectively provided by the at least one network supporting the localized service.

24. The processor of claim 21, wherein the information indicating availability of a first network supporting the localized service is an indication received in a first system information block broadcast by a base station of a network providing service to the apparatus.

25. The processor of claim 24, wherein the at least one controller is further configured to cause the processor to receive a second system information block comprising network information including at least one of a service identifier and a human-readable service name of the first network supporting the localized service.
